(19) United States
(12) Patent Application Publication
(10) Pub. No.: US 2002/0172175 A1
(43) Pub. Date: Nov. 21, 2002

(54) Communication device

(76) Inventor: Mineo Okamura, Kawasaki (JP)

Correspondence Address: Rosenman & Colin LLP, 575 Madison Avenue, New York, NY, 10022-2585, US

(21) Appl. No.: 09/960,098

(22) Filed: Sep. 21, 2001

(30) Foreign Application Priority Data
May 15, 2001 (JP) 2001-145378

(51) Int. Cl. H04Q 7/28; H04J 3/24; H04L 12/56

(52) U.S. Cl. 370/338; 370/349; 370/401

(57) ABSTRACT

In a managing router (communication device) managing a mobile node, the managing router releases an older tunnel already established so as to prevent the number of all tunnels established between the managing communication device itself and an accommodating router of a mobile node from exceeding e.g. a predetermined threshold value. Also, when the number of all tunnels presently established for all mobile nodes exceeds a predetermined threshold value, the managing router rejects a new tunnel establishment, or releases an older tunnel to establish a new tunnel. Also, by classifying the mobile nodes into a plurality of classes based on a plurality of threshold values, the establishment of the new tunnel is rejected or executed based on the threshold value corresponding to the class to which the mobile node belongs. Furthermore, the managing router determines a lifetime of a tunnel established between the communication device itself and the accommodating router of the mobile node, based on the number of all (working) tunnels presently established by the communication device itself.

### BACKGROUND OF THE INVENTION

1. Field of the Invention

The present invention relates to a communication device, and in particular to a communication device managing a mobile node.

In a mobile communication of an IP network, an address of a mobile node is an IP address having the same form as that of a fixed node performing a conventional communication. Each mobile node is managed by a managing router (generally referred to as home agent) as a communication device determined by the IP address.

Data transmitted from a transmitting source device (generally referred to as host) are transmitted to the mobile node through the managing router and a mobile node accommodating router (generally referred to as foreign agent) which accommodates the mobile node. At this time, a tunnel is required to be established between the managing router and the accommodating router.

2. Description of the Related Art

FIG. 11 shows an example of a mobile communication in a general IP network. A managing router 110 located in a network 510, an external router 200 located in a network 520, and a host 400 are connected to the Internet 500.

In case the managing router 110 is a home agent managing a mobile node 300, the network address of the network 510 is included in the IP address of the mobile node 300, so that the managing router 110 performs a mobile IP communication service to the mobile node 300.

When moving from the network 510 to the network 520 as shown, the mobile node 300 registers itself in the external router 200. The external router 200 registers itself in the managing router 110 of the mobile node 300 to become an accommodating router of the mobile node 300.

It is to be noted that while the networks 510 and 520 are shown outside of the Internet 500 for convenience sake in FIG. 11, they are included in the Internet 500.

A packet (data) from the host 400 addressed to the mobile node 300 is once transmitted to the managing router 110 of the mobile node 300. After encapsulation for changing the address of the received packet to the IP address of the accommodating router 200, the managing router 110 transmits the packet. Thus, the packet is routed to the accommodating router 200.

Namely, the managing router 110 encapsulates the packet between the managing router 110 itself and the accommodating router 200, and transmits, through a mobile IP tunnel 71 established thereby, the packet to the accommodating router 200.

The accommodating router 200 transmits the packet whose address is returned to the IP address of the original mobile node 300 by decapsulation, to the mobile node 300.

Thus, the communication from the host 400 to the mobile node 300 can be performed without changing the IP address of the mobile node 300, and a TCP connection can be maintained even during the movement. Namely, it becomes possible to avoid the change of the IP address of the mobile node 300 itself every time the mobile node moves between the accommodating routers, its address management, and its path control complicated therewith.

It is to be noted that the reverse communication from the mobile node 300 to the host 400 is performed by a regular IP transmission through the accommodating router 200.

FIG. 12 shows a tunnel establishment in the mobile IP communication through such a prior art managing router 110. The managing router 110 of the mobile node 300, and external routers 200-203 are connected to the Internet 500. When the mobile node 300 sequentially moves as shown by movements \mathring{1}-\mathring{4}, that is, moves from the network 510 where the managing router 110 is located to the networks (not shown) where the routers 200, 201, 202, and 203 are located, mobile IP tunnels 71-74 are established between the managing router 110 and each of the routers 200-203.

The reason why a plurality of tunnels 71-74 are established in this way without releasing a previous tunnel is to avoid such a case that when the tunnel 73 is released immediately after the establishment of the tunnel 74 and the mobile node 300 returns from the router 203 to the router 202, a resource can not be secured so that the tunnel 73 can not be established.

The tunnel is released in case of the release under the initiative of the mobile node, or a lifetime timeout. Thus, the establishment/release of the tunnel is performed not under the initiative of the router but under the initiative of the mobile node.

As a result, when the managing mobile node moves many times, the managing router 110 has a problem that the resource for establishing the tunnel is limited.

### SUMMARY OF THE INVENTION

It is accordingly an object of the present invention to provide a communication device which manages a mobile node and which reduces the number of tunnels established between the communication device itself and an external router accommodating the mobile node.

In order to achieve the above-mentioned object, a communication device according to the present invention releases, with a movement of a single mobile node to be managed, an older tunnel already established so as to prevent a number of all tunnels established between the communication device itself and an accommodating communication device accommodating the mobile node from exceeding a predetermined threshold value.

FIG. 1 shows a principle (1) of a router which is a communication device according to the present invention. The arrangement of FIG. 1 is the same as that of the prior art shown in FIG. 12. The present invention relates to a router (hereinafter, referred to as managing router) 100 for managing a mobile node 300. In the managing router 100, the maximum tunnel number (binding number) which can be established for the mobile node 300 is set with a predetermined threshold value =N.

In case the maximum tunnel number is set with “3” for example, with the sequential movements of the mobile node 300 to the external routers 200, 201, and 202, tunnels 71, 72, and 73 are sequentially established between the managing router 100 which manages the mobile node 300 and the accommodating (external) routers 200, 201, and 202 which accommodate the mobile node 300.

When the mobile node 300 further moves toward the router 203, the managing router 100 releases the older tunnel 71 so as to prevent the number of tunnels from exceeding 3, and then newly establishes the tunnel 74 between the managing router 100 itself and the accommodating router 203.

Thus, more than N tunnels are not established for each mobile node 300, thereby eliminating the limit to the resource of the managing router 100.

Also, in the present invention, a communication device which establishes, with a movement of a mobile node, a tunnel for transferring a communication packet with the mobile node to an accommodating communication device accommodating the mobile node at a moved destination, and which manages the mobile node, comprises: means for controlling a number of the tunnel to be within a predetermined number.

Namely, the communication device (router) managing the mobile node, with the movement of the mobile node, establishes tunnels for transferring the communication packet with the mobile node to the communication device accommodating the mobile node at the moved destination. The communication device controls the number of the tunnels to be within a predetermined number. Different from the above-mentioned invention, older tunnels are not always released in this control, and various control methods can be adopted including a prohibition of adding the number of the tunnels.

Also, in the present invention according to the above-mentioned invention, the threshold value may comprise a unique value to each mobile node.

Namely, the number of tunnels which can be established can be set for each mobile node. Thus, it becomes possible to set the number of the tunnels according to the importance degree of the mobile node for example.

Also, a communication device according to the present invention, when a new tunnel is required to be established with a movement of a single mobile node to be managed, a number of all tunnels presently established for all mobile nodes by the communication device itself exceeds a predetermined threshold value, and no tunnel corresponding to the single mobile node is established, rejects the establishment of the new tunnel, and releases an older tunnel corresponding to the single mobile node to establish the new tunnel when at least one tunnel corresponding to the single mobile node is established.

FIG. 2 shows a principle (2) of the router 100 which is the communication device. In this router 100, a mobile node to be managed is determined. A predetermined threshold value (e.g. the maximum tunnel number which can be established within the router, hereinafter occasionally referred to as maximum tunnel number within the router) TH1 is set for the number “m” of the entire tunnels (working tunnel number) presently established by the router 100.

In case a new tunnel is required to be established, with the movement of the mobile node 300, between a new accommodating router which accommodates the mobile node 300 and the router managing the mobile node 300, the number of the entire tunnels presently established for the entire mobile nodes managed exceeds the threshold value TH1, and no tunnel corresponding to the mobile node 300 is established, the managing router 100 rejects the establishment of the tunnel. When at least one tunnel corresponding to the mobile node 300 is established, an older tunnel corresponding to the mobile node 300 is released to establish a new tunnel.

Thus, the managing router 100 prevents tunnels equal to or more than the maximum tunnel number manageable from being established.

Also, in the present invention according to the above-mentioned invention, the mobile nodes may be classified into a plurality of classes based on a plurality of threshold values, and the establishment of the new tunnel may be rejected or executed based on the threshold value corresponding to the class to which the mobile node belongs.

As shown in FIG. 2, a plurality of threshold values such as the threshold value (maximum tunnel number) TH1, the threshold value (the sharable tunnel number) TH2 are set for the entire tunnel number “m” presently established by the router. The mobile nodes 300 and 310 (both not shown) for example, respectively belong to a plurality of classes classified by the maximum tunnel number TH1 and the sharable tunnel number TH2.

In the presence of a request of a new tunnel establishment corresponding to the mobile node 300, the router compares the maximum tunnel number TH1 corresponding to the mobile node 300 with the entire tunnel number “m” presently established to reject or execute the tunnel establishment mentioned above.

When a new tunnel is required to be established corresponding to the mobile node 310, the router compares the entire tunnel number “m” presently established with the sharable tunnel number TH2 to reject or execute the tunnel establishment.

Because the maximum tunnel number TH1>the sharable tunnel number TH2, the tunnel establishment is regulated earlier for the mobile node 310 than for the mobile node 300. Thus, the mobile nodes are classified according to the importance degree for example, thereby enabling the number of tunnels which can be established to be regulated.

Furthermore, the router according to the present invention determines a lifetime, with a movement of a mobile node to be managed, of a tunnel established between the communication device itself and an accommodating communication device accommodating the mobile node, based on a number of all tunnels presently used by the communication device itself.

FIG. 3 shows a principle (3) of the router 100 which is the communication device. The router 100 is a managing router which manages the mobile nodes 300 and 310. The managing router 100 determines the lifetime of the tunnel established between the accommodating router which accommodates the mobile node 300 and the managing router itself.

In case the entire (working) tunnel number “m” presently established in the router 100 does not exceed e.g. a threshold value (tunnel number regulated by lifetime) TH3 before point T4, the managing router 100 sets the lifetime of the tunnel 71 to 600 seconds (at point T3).

When the number of the tunnels presently used exceeds the tunnel number TH3 regulated by lifetime at point T4, the router 100 sets e.g. the lifetime of the tunnel 71 to 300 seconds (at points T5-T7).

Thus, in case the entire tunnel number “m” presently used is large for example, the managing router 100 shortens the lifetime of the tunnel, thereby enabling the established tunnels to be released earlier, and the limit to the resource to be reduced.

Also, in the present invention according to the above-mentioned invention, the lifetime may be notified to the mobile node.

In FIG. 3, when the mobile node 310 moves to be accommodated in the external (accommodating) router 210 for example, the mobile node 310 sends a registration request signal 81a to the external (accommodation) router 210 to request the tunnel establishment (at point T5).

The accommodating router 210 sends the registration request signal 81a to the managing router 100 in the form of a registration request signal 81b, so that the request for the tunnel establishment is relayed. The managing router 100 establishes the tunnel, and sends, to the accommodating router 200, the registration reply signal 82b in which the lifetime of the established tunnel=300 seconds is set, so that the accommodating router 200 transmits the registration reply signal 82a in which the lifetime is set to the mobile node 310 (at point T6).

It is to be noted that while in the above, the managing router 100 notifies the lifetime to the mobile node 310 by a trigger of the registration request signal 81a of the mobile node 310, the notifying method is not limited thereto.

Thus, the mobile node 310 can recognize that the lifetime of the tunnel 72, established between the accommodating router 210 and the managing router 100, is set with 300 seconds (at point T7).

### BRIEF DESCRIPTION OF THE DRAWINGS

FIG. 1 is a block diagram showing an operation principle (1) of a router which is a communication device according to the present invention;

FIG. 2 is a block diagram showing an operation principle (2) of a router which is a communication device according to the present invention;

FIG. 3 is a block diagram showing an operation principle (3) of a router which is a communication device according to the present invention;

FIG. 4 is a block diagram showing an embodiment of a router which is a communication device according to the present invention;

FIG. 5 is a diagram showing an example of tunnel regulating information included in a router which is a communication device according to the present invention;

FIG. 6 is a diagram showing an example of an established tunnel list included in a router which is a communication device according to the present invention;

FIG. 7 is a flow chart showing an example of a regulating process flow of the maximum multiplexing number in a router which is a communication device according to the present invention;

FIG. 8 is a diagram showing an interrelationship of tunnel regulating information included in a router which is a communication device according to the present invention;

FIG. 9 is a flow chart showing an example of a lifetime regulating process flow in a router which is a communication device according to the present invention;

FIG. 10 is a flow chart showing an example of a tunnel number regulating process flow in a router which is a communication device according to the present invention;

FIG. 11 is a block diagram showing a general mobile IP communication network; and

FIG. 12 is a block diagram showing an example of a tunnel establishment in a prior art router.

Throughout the figures, like reference numerals indicate like or corresponding components.

### DESCRIPTION OF THE EMBODIMENTS

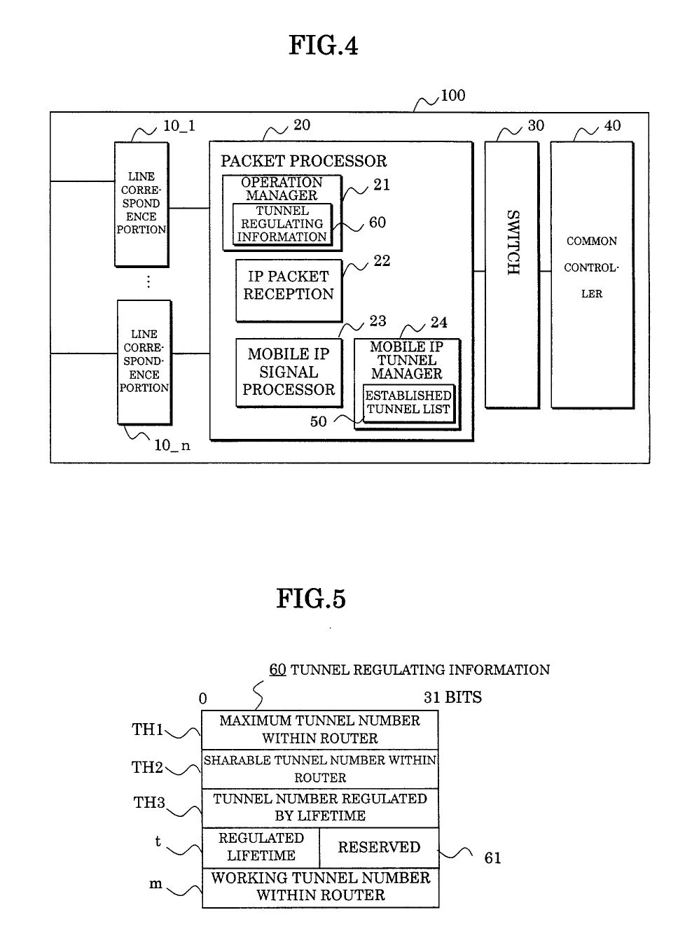

FIG. 4 shows a router which is an embodiment of a communication device according to the present invention. The managing router 100 is composed of line correspondence (accommodating) portions 10_1-10_n, a packet processor 20, a switch 30, and a common controller 40. The packet processor 20 is composed of an operation manager 21, an IP packet reception 22, a mobile IP signal processor 23, and a mobile IP tunnel manager 24.

FIG. 5 shows tunnel regulating information 60 managed by the operation manager 21. This regulating information 60 is composed of a 32-bit maximum tunnel number TH1 indicating the number of tunnels which can be registered within the router, a 32-bit sharable tunnel number TH2 indicating the number of sharable tunnels regardless of user's attributes within the router, a 32-bit tunnel number TH3 regulated by lifetime indicating the number of tunnels which serves to regulate the lifetime of the tunnel, a regulating lifetime “t” indicating the lifetime of the regulated tunnel, a 32-bit working tunnel number “m” indicating the number of tunnels presently registered (working) within the router, and a 16-bit reserved portion 61.

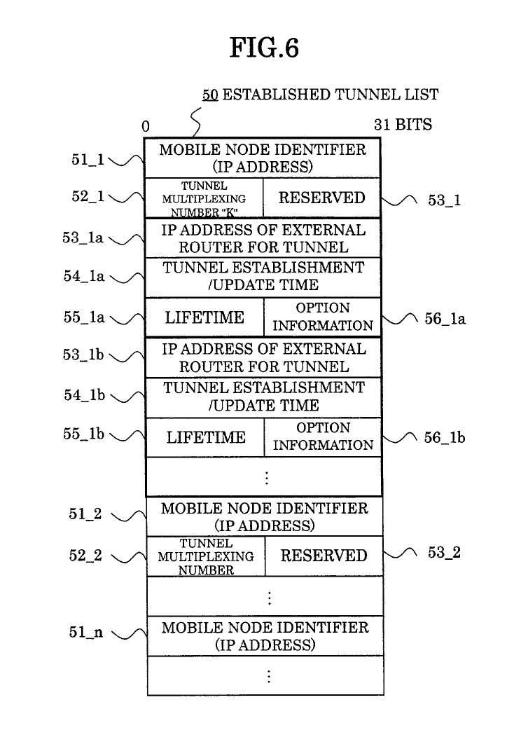

FIG. 6 shows a tunnel list 50 managed by the mobile IP tunnel manager 24. This list 50 is composed of, respectively for n mobile nodes 300_1-300_n managed by the router 100, a 32-bit mobile node identifier (IP address) (portion) 51_1, a 16-bit tunnel multiplexing number (portion) 52_1, a 16-bit reserved (portion) 53_1, IP address (portions) of external routers for tunnels 53_1a-53_1n, tunnel establishment/update time (portions) 54_1a-54_1n, tunnel lifetime (portions) 55_1a-55_1n, and option information (tunneling methods) (portions) 56_1a-56_1n corresponding to n tunnels designated by the tunnel multiplexing number (portion) 52_1.

It is to be noted that the above reference numerals are indicated by the reference numerals corresponding to the mobile node 300_1. Also, hereinafter, occasionally the reference numerals of the mobile node identifiers, the tunnel multiplexing numbers, the IP addresses of the external routers for the tunnels, the tunnel establishment/update times, the tunnel lifetimes, and the option information corresponding to the mobile nodes 300_1-300_n are respectively represented by reference numerals 51, 52, 53, 54, 55, and 56.

Registering Process

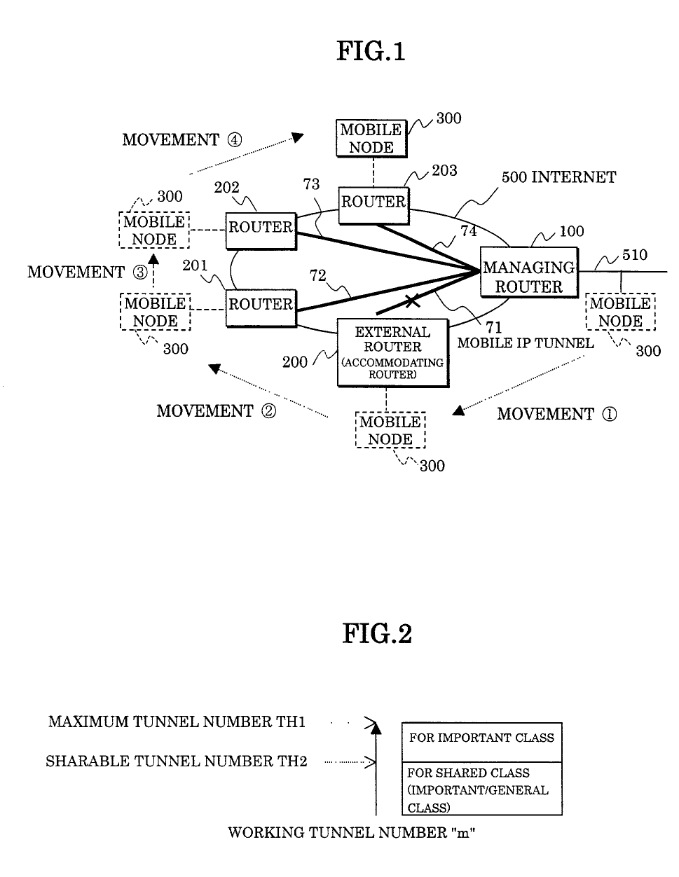

In FIG. 1, when moving from the managing router 100 to the external router 200, the mobile node 300 detects service information transmitted by the external router 200 to recognize that the mobile node 300 itself has entered the area of the external router 200.

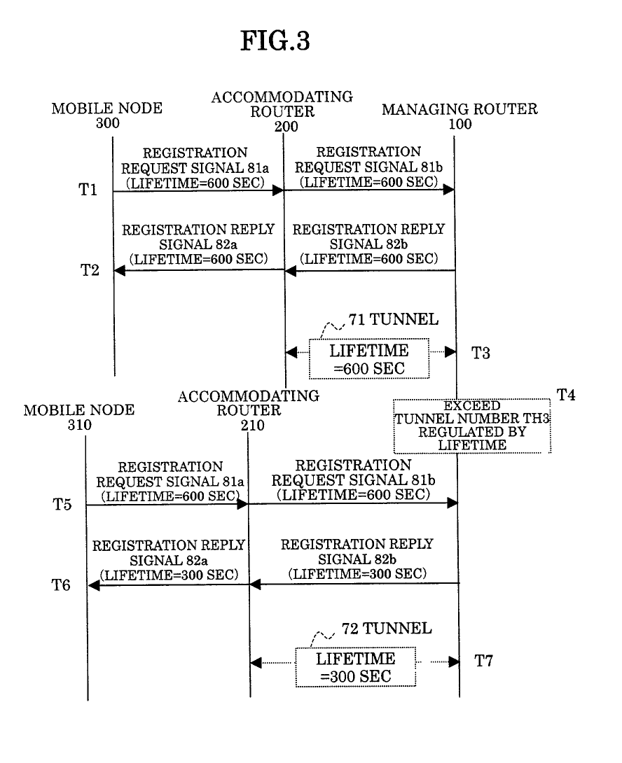

The mobile node 300 registers itself in the external (accommodating) router 200 and managing router 100 by the registration request signals 81a and 81b (hereinafter, occasionally represented by a reference numeral 81) (see FIG. 3). In the registration request signal 81, the lifetime 55 of the tunnel between the accommodating router 200 and the managing router 100, the option information 56, and the like are included, besides the IP address 53 of the accommodating router 200 and the IP address of the managing router.

The registration request signals 81 transmitted by the mobile node 300 are respectively investigated by the external router 200 and the managing router 100, so that the result is returned in the form of the registration reply signals 82a and 82b (hereinafter, occasionally represented by a reference numeral 82) (see FIG. 3).

When the registration is permitted, the lifetime 55 of the tunnel between the external router 200 and the managing router 100 is set in the registration reply signal 82. In the external router 200/managing router 100, the accommodated mobile node 300 as well as the tunnel information between the external router 200 and the managing router 100 are respectively held in a visitor list (not shown) and the tunnel list 50 (see FIG. 6). It is to be noted that the lifetime 55 is updated at any time by a repeated registration request signal 81 from the mobile node 300.

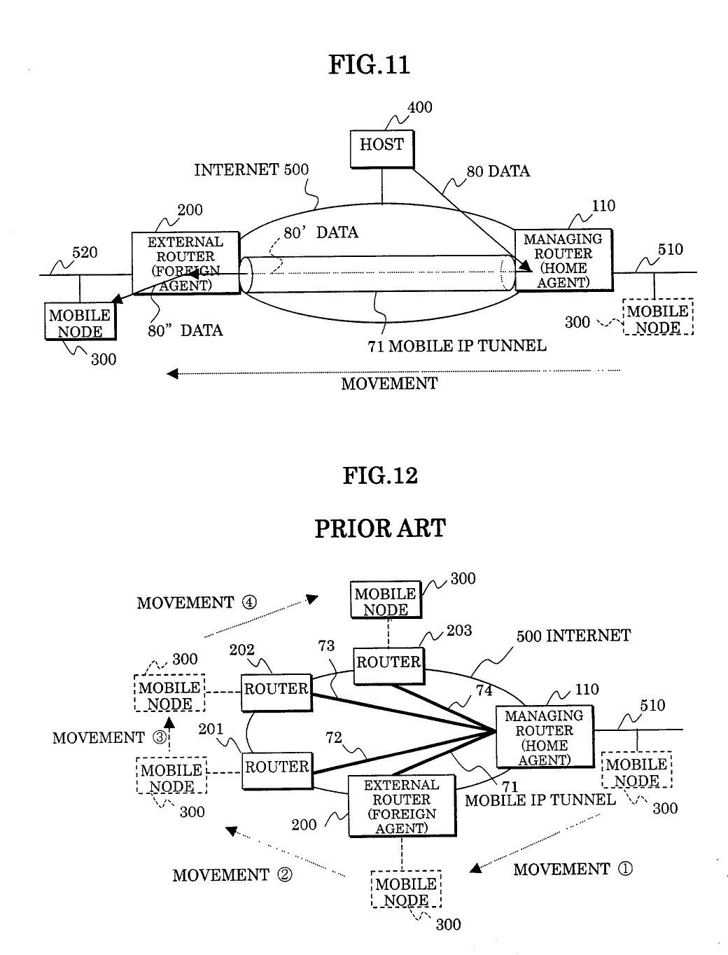

After executing the above-mentioned registering process, the data from the mobile node 300 to e.g. the host 400 (see FIG. 11) are routed in the same way as the regular IP data. Oppositely, the data from the host 400 to the mobile node 300 are once routed to the managing router 100, so that the managing router 100 transfers the data to the accommodating router 200 based on the tunnel list 50 (see FIG. 6) through the tunnel 71 by the IP encapsulation technology. The accommodating router 200 which has received the corresponding data decapsulates based on the visitor list to transfer the data to the mobile node 300.

Also, the established tunnel 71 is released by a trigger (1) of the tunnel lifetime timeout, and by a trigger (2) of a deletion request (registration request signal 81 including the lifetime=0) from the mobile node 300.

It is to be noted that no tunnel release is notified by positive transmission of the mobile IP signal when the tunnel is released, so that the accommodating router 200 and the managing router 100 respectively delete the tunnel 71 from the visitor list and the tunnel list 50.

Embodiment (1): Maximum Mobile Node Tunnel Multiplexing Number Regulating Control

In the above-mentioned registering process, the router 100 performs controls as follows in order to regulate the maximum tunnel multiplexing number per mobile node, in which the regulation of the maximum multiplexing number per mobile node is performed according to the maximum mobile node multiplexing number “L” (not shown) managed by a managing server by a contract:

The registration request signal 81 transmitted from the mobile node 300 is received by the router 100 through the accommodating router 200. In the router 100, the IP packet reception 22 analyzes the registration request signal 81 received through the line correspondence portion 10. In case the registration request signal 81 is a mobile IP control signal, the registration request is notified to the mobile IP signal processor 23 together with its information element.

In case the information element is abnormal, the signal processor 23 edits the information element in which a corresponding abnormal code is set and notifies it to the IP packet reception 22. The IP packet reception 22 returns the registration reply signal 82 to the mobile node.

In case the information element is normal, the signal processor 23 notifies, to the tunnel manager 24, the registration in the tunnel list 50 together with the mobile node identifier (IP address), the IP address of the external router for the tunnel, the tunnel establishment/update time, the tunnel lifetime, and the option information (tunneling method).

The tunnel manager 24 retrieves the tunnel list of the mobile node to be registered, and the following process is performed:

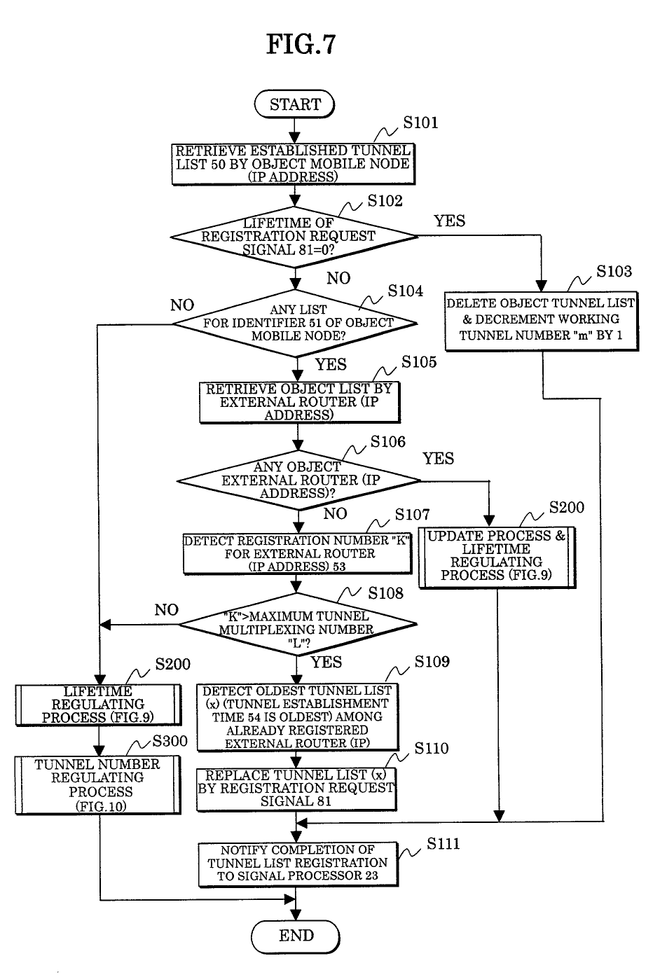

FIG. 7 shows a process flow of the tunnel manager 24. Hereinafter, the tunnel list registering process will be described referring to FIG. 7.

Step S101: The tunnel manager 24 checks whether or not the IP address of the mobile node is registered in the tunnel list.

Steps S102 and S103: In case the lifetime included or set in the registration request signal 81 is 0, the object tunnel list is deleted, so that the working tunnel number “m” is decremented by 1 (see FIG. 5). Hereinafter, the case where the object mobile node is not registered in the tunnel list will be described.

Steps S102 and S104: In case the lifetime included in the registration request signal 81 is not 0, the tunnel manager 24, as a new registration, additionally registers the mobile node identifier (IP address) 51, the IP address 53 of the external router for the tunnel, the tunnel establishment time 54, the tunnel lifetime 55, and the option information 56. It is to be noted that the regulation of the tunnel number within the router will be described later.

Steps S104-S106, S200, and S111: These steps correspond to the case where the object mobile node is already registered in the tunnel list. The tunnel manager 24 checks the IP address 53 of the external router for the tunnel against the address in the list. When they coincide with each other, the request is treated as the update request of the same tunnel. After updating the tunnel establishment time 54 and the lifetime 55 of the object mobile node within the list 50, the completion of the registration is notified to the signal processor 23. The operation of the lifetime regulating process at step S200 will be described later.

Steps S106-S108, S200, and S300: In case the IP address 53 of the external router for the tunnel does not coincide with the address in the tunnel list, the tunnel manager 24 treats the request as a multiplexing establishment of another tunnel, detects the registration number, compares it with the maximum tunnel multiplexing number 52, so that, when the registration number (tunnel multiplexing number “k”) becomes equal to or less than the maximum multiplexing number “L”, by adding the tunnels, the IP address 53 of the external router for the tunnel, the tunnel establishment time 54, the tunnel lifetime 55, and the option information 56 are additionally registered.

Steps S108-S110: When the registration number exceeds the maximum multiplexing number by the addition, the tunnel manager 24 detects the oldest information, i.e. the oldest list in which the tunnel establishment time is the oldest, from the information already registered, so that the list information is replaced by this additional registration.

Step S111: After performing the above-mentioned registering process, the tunnel manager 24 notifies the completion of the list registration to the signal processor 23.

The signal processor 23 which has received the notification edits the information element to return the registration reply signal 82 to the mobile node 300 through the IP packet reception 22 and the line correspondence portion 10.

Embodiment (2): Tunnel Lifetime Regulating Process

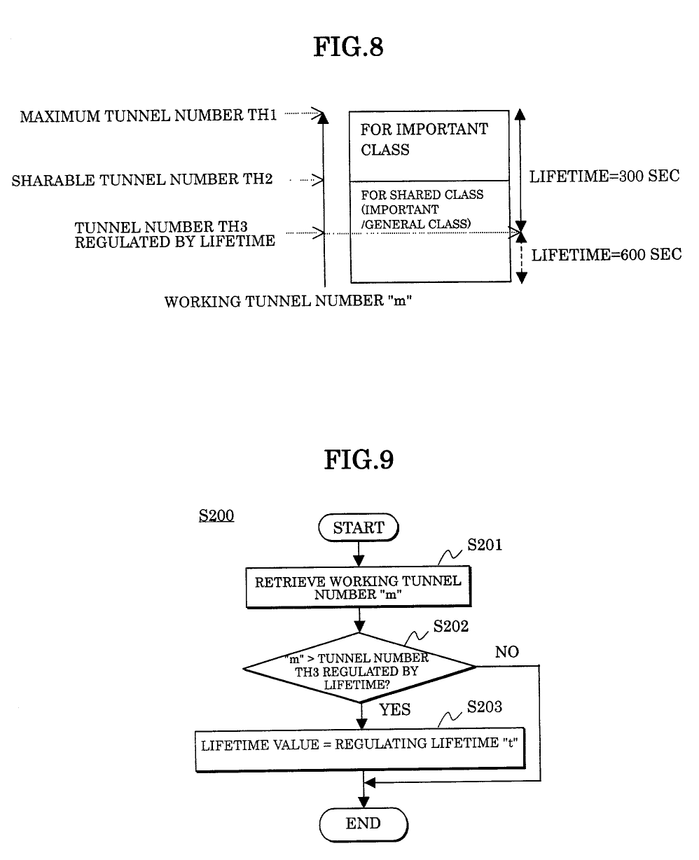

FIG. 8 shows a relationship of the tunnel regulating information shown in FIG. 5. Namely, when the working tunnel number “m” in the managing router 100 exceeds the tunnel number TH3 regulated by lifetime, the tunnel lifetime is set with e.g. 300 seconds from 600 seconds.

FIG. 9 shows a procedure of the lifetime regulating process shown at step S200 mentioned above. Hereinafter, the process procedure will be described.

Steps S201 and S202: The mobile IP signal processor 23 receives the registration request signal 81 transmitted from the mobile node 300, detects the working tunnel number “m” managed by the operation manager 21 when notifying the list registration to the tunnel manager 24, and compares the working tunnel number “m” with the tunnel number TH3 regulated by lifetime. When it is found that the working tunnel number “m”≦the tunnel number TH3 regulated by lifetime, the signal processor 23 does nothing to end the process.

Step S203: In case the working tunnel number “m”>the tunnel number TH3 regulated by lifetime (at point T4 in FIG. 3), to promote releasing the tunnel set, the tunnel manager 24 sets the lifetime 55 to regulating lifetime “t” (=300 seconds), and notifies the completion of the list registration including the regulating lifetime “t”=300 seconds to the signal processor 23. The signal processor 23 edits and replies the registration reply signal 82 together with the notified regulating lifetime “t” (see points T4-T6 in FIG. 3).

It is to be noted that with regard to the registration request signal 81 of updating the already registered tunnel, the similar lifetime regulating process is performed.

Embodiment (3): Tunnel Number Regulating Process within Router

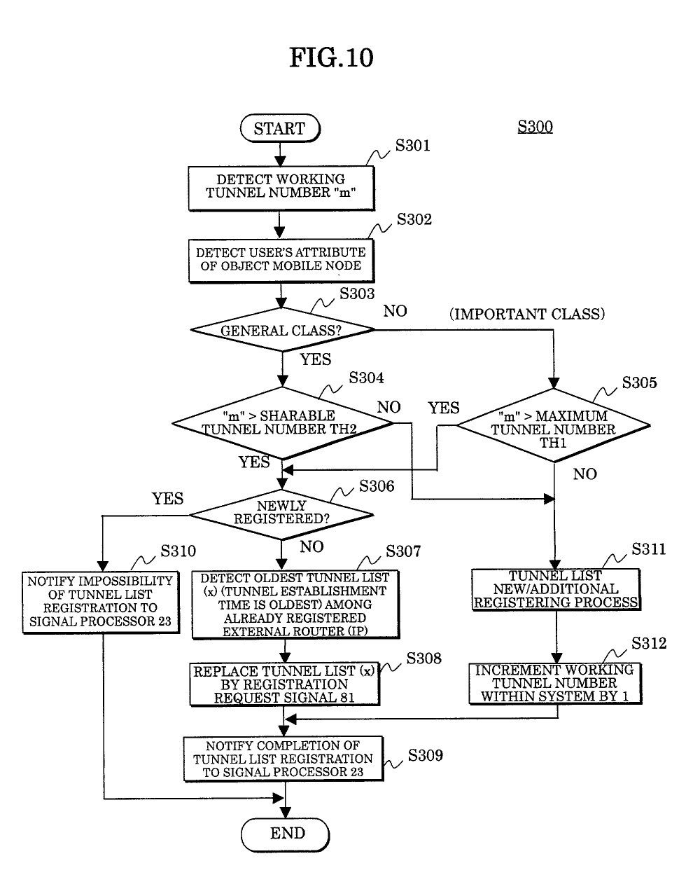

FIG. 10 shows a procedure of the tunnel number regulating process within router shown at step S300 mentioned above. Hereinafter, this process procedure will be described.

In the tunnel number regulating process, when the working tunnel number “m” exceeds the sharable tunnel number TH2, the total number of the tunnels for the “general class” is regulated so as not to increase. When the working tunnel number “m” exceeds the maximum tunnel number TH1, the total number of the tunnels for the “general class” and the “important class” is regulated so as not to increase.

The signal processor 23 receives the registration request signal 81 transmitted from the mobile node, and the list registration is notified to the tunnel manager 24. When the registration is a new registration or an additional registration (multiplexing setting of tunnel), the following process is performed, in which it is to be noted that this process is performed based on the user's attribute (“important class”/“general class”) of the mobile node managed in association with the managing server.

Steps S301-S303 in FIG. 10: After detecting the working tunnel number “m”, the signal processor 23 detects whether the user's attribute of the object mobile node is “general class” or “important class”.

Hereinafter, the case where the attribute of the object mobile node is the “general class” will be firstly described.

Steps S304, S306, and S310: In case the user's attribute of the object mobile node is “general class”, the signal processor 23 compares the working tunnel number “m” with the sharable tunnel number TH2. In case the working tunnel number “m”>the sharable tunnel number TH2, whether the registration is a new registration or an additional registration is determined. When it is found to be a new registration, the tunnel manager 24 notifies impossibility of the list registration to the signal processor 23 to end the process.

When it is not found to be a new registration at step S306, the process proceeds to step S307.

Steps S307-S309: In case the working tunnel number “m” exceeds the sharable tunnel number TH2 by performing an additional registration, the tunnel manager 24 replaces the regular registration list by the oldest list (the list in which the tunnel establishment time is the oldest) in the same way as the above-mentioned maximum multiplexing number regulating process, so that the completion of the list registration is notified to the signal processor 23.

Steps S304, S311, S312, and S309: When the working tunnel number “m” is equal to or less than the sharable tunnel number TH2, the tunnel manager 24 sets the information in the established tunnel list 50 as a new registration or an additional registration to notify the completion of the list registration to the signal processor 23. Also, the operation manager 21 increments the working tunnel number “m” to be managed by 1.

Steps S303 and S305: When the user's attribute is not “general class”, that is “important class”, the signal processor 23 compares the working tunnel number “m” with the maximum tunnel number TH1, so that whether or not the working tunnel number “m”>the maximum tunnel number TH1 is determined.

Hereafter, the same process as that for the “general class” is performed. The difference between the processes for the “general class” and for the “important class” is that the threshold value compared with the working tunnel number “m” is the sharable tunnel number TH2 in the “general class”, and the maximum tunnel number TH1 in the “important class”.

Steps S306 and S310: When the corresponding registration is found to be a new one, the tunnel manager 24 notifies the impossibility of the list registration to the signal processor 23.

Steps S306-S309: The tunnel manager 24 replaces the oldest list by the registration concerned to notify the completion of the registration to the signal processor 23.

Steps S311, S312, and S309: The tunnel manager 24 newly or additionally makes registrations, so that the operation manager 21 increments the working tunnel number “m” by 1 to notify the completion of the registration to the signal processor 23.

Besides the above-mentioned description, when a tunnel release trigger, e.g. lifetime timeout or deletion request from the mobile node arises, the corresponding tunnel list information is deleted and the working tunnel number “m” is decremented by 1.

It is to be noted that while in the above-mentioned embodiments of the present invention, a router is particularly mentioned as a communication device managing a mobile node, the present invention can be applied to not only the router but also other various communication devices.

As described above, a managing communication device according to the present invention is arranged such that an older tunnel already established is released so as to prevent a number of all tunnels established between the managing communication device itself and an accommodating communication device of a single mobile node from exceeding a predetermined threshold value. Therefore, the resource of the managing communication device 100 is prevented from being limited. Also, by setting the tunnel number which can be established per mobile node, the tunnel number can be set e.g. depending on the importance of the mobile node.

Also, the managing communication device according to the present invention is arranged such that the managing communication device rejects a new tunnel establishment, or releases an older tunnel to establish a new tunnel, when the entire tunnel number presently established for all mobile nodes exceeds a predetermined threshold value. Therefore, the case can be avoided where the tunnels more than the maximum tunnel number are established.

Also, the mobile nodes are classified into a plurality of classes based on a plurality of threshold values, and the establishment of the new tunnel is rejected or executed based on the threshold value corresponding to the class to which the mobile node belongs. Therefore, establishable tunnel number can be regulated depending on the importance of the mobile node.

Also, the managing communication device determines a lifetime of a tunnel established between the communication device itself and an accommodating communication device of the mobile node, based on the number of all tunnels presently used by the communication device itself, thereby enabling the established tunnel to be released earlier and the limit to the resource to be reduced.

Namely, the managing communication device according to the present invention enables accurate and efficient resource management to be performed according to the resource capacity of the managing communication device itself and the user's attribute of the mobile node, thereby enabling the resource to be used efficiently and the service for the user to be improved.

What we claim is:

1. A communication device which releases, with a movement of a single mobile node to be managed, an older tunnel already established so as to prevent a number of all tunnels established between the communication device itself and an accommodating communication device accommodating the mobile node from exceeding a predetermined threshold value.

2. The communication device as claimed in claim 1 wherein the threshold value comprises a unique value to each mobile node.

3. A communication device which establishes, with a movement of a mobile node, a tunnel for transferring a communication packet with the mobile node to an accommodating communication device accommodating the mobile node at a moved destination, and which manages the mobile node, comprising:
means for controlling a number of the tunnel to be within a predetermined number.

4. A communication device which, when a new tunnel is required to be established with a movement of a single mobile node to be managed, a number of all tunnels presently established for all mobile nodes by the communication device itself exceeds a predetermined threshold value, and no tunnel corresponding to the single mobile node is established, rejects the establishment of the new tunnel, and releases an older tunnel corresponding to the single mobile node to establish the new tunnel when at least one tunnel corresponding to the single mobile node is established.

5. The communication device as claimed in claim 4 wherein the mobile nodes are classified into a plurality of classes based on a plurality of threshold values, and the establishment of the new tunnel is rejected or executed based on the threshold value corresponding to the class to which the mobile node belongs.

6. A communication device which determines a lifetime, with a movement of a mobile node to be managed, of a tunnel established between the communication device itself and an accommodating communication device accommodating the mobile node, based on a number of all tunnels presently used by the communication device itself.

7. The communication device as claimed in claim 6 wherein the lifetime is notified to the mobile node.
